(19) United States
(12) Patent Application Publication
(10) Pub. No.: US 2025/0329010 A1
(43) Pub. Date: Oct. 23, 2025

(54) ROUGHNESS ESTIMATION FOR EXAMINATION OF SEMICONDUCTOR SPECIMENS

(71) Applicant: Applied Materials Israel Ltd., Rehovot (IL)

(72) Inventors: Pierre Jean-Marie Julien CHEVALIER, Grenoble (FR); Jean-François Albert BOUGRON, Fontaine (FR)

(21) Appl. No.: 18/642,660

(22) Filed: Apr. 22, 2024

(51) Int. Cl. G06T 7/00; G06V 10/46; G06V 10/98

(52) U.S. Cl. CPC G06T 7/001; G06V 10/46; G06V 10/993; G06T 2207/30148

(57) ABSTRACT

There is provided a system and method of estimating edge roughness of a feature on a semiconductor specimen. The method includes obtaining a set of images capturing the feature and design data of the feature; providing, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and generating power spectral density (PSD) data based on edge placement difference (EPD) between each target contour in the set of target contours and the reference contour, wherein the PSD data is usable for estimating edge roughness of the feature.

### TECHNICAL FIELD

The presently disclosed subject matter relates, in general, to the field of examination of a semiconductor specimen, and more specifically, to roughness estimation for a manufactured specimen.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

The manufacturing process of a semiconductor device includes various intricate process steps, such as lithography, etching, depositing, planarization, growth (such as, e.g., epitaxial growth), and implantation, etc., to create precise patterns and features on semiconductor substrates. Examination processes, including various metrology operations and measurements, are performed at various process steps during semiconductor fabrication to ensure that the fabricated features meet the desired specifications. In particular, estimating precise edge profiles has become increasingly critical to obtain accurate measurements.

Edge roughness generally refers to deviations or irregularities along the edges of semiconductor features, typically observed as fluctuations in dimensions of the features. These irregularities can arise from various factors during semiconductor fabrication processes or subsequent handling, leading to non-uniform edge profiles.

As the dimensions of integrated circuit features continue to decrease, the impact of edge roughness on process control and device performance becomes more pronounced. For instance, edge roughness can introduce variations in the dimensions of features, making it challenging to accurately measure critical dimensions such as linewidths or feature sizes, which are crucial for controlling the manufacturing process. In some cases, edge roughness may possibly alter the effective feature dimensions, which directly impact device characteristics such as electrical conductivity, optical properties, or mechanical stability, etc., thus potentially leading to device malfunctions and yield losses.

Therefore, accurate characterization and control of edge roughness are essential during examination processes, for ensuring the quality and reliability of fabricated semiconductor devices, so as to promote higher yield.

### SUMMARY

In accordance with certain aspects of the presently disclosed subject matter, there is provided a computerized system of estimating edge roughness of a feature on a semiconductor specimen, the system comprising a processing circuitry configured to obtain a set of images capturing the feature and design data of the feature; provide, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and generate power spectral density (PSD) data based on edge placement difference (EPD) between each target contour in the set of target contours and the reference contour, wherein the PSD data is usable for estimating edge roughness of the feature.

In addition to the above features, the system according to this aspect of the presently disclosed subject matter can comprise one or more of features (i) to (xiv) listed below, in any desired combination or permutation which is technically possible:
(i). The feature can be in a shape of a line or a two-dimensional (2D) polygon.
(ii). The set of images can comprise a plurality of images acquired by an examination tool from a plurality of sites on the semiconductor specimen, each site containing an instance of the feature.
(iii). The transformation can be obtained based on a plurality of pairs of corresponding points from the actual contour and the reference contour.
(iv). The target contour for the given image can be provided by aligning the given image with the reference contour extracted from the design data; sampling a plurality of reference points from the reference contour; identifying a plurality of image points on the given image corresponding to the plurality of reference points, giving rise to a plurality of pairs of corresponding points, the plurality of image points constituting the actual contour; computing the transformation between the actual contour and the reference contour based on the plurality of pairs of corresponding points; and correcting the actual contour based on the transformation, to obtain the target contour corresponding to the given image.
(v). The plurality of image points can be identified by placing a plurality of strips respectively at locations of the plurality of reference points, each strip extending in a direction perpendicular to the reference contour, and obtaining, from each strip, a respective image point based on gray level intensities along the strip.
(vi). The transformation can be an affine transformation representative of at least one of translation, rotation, and scaling of the actual contour with respect to the reference contour.
(vii). The PSD data can be obtained by averaging among a set of individual PSD data, each corresponding to an EPD between a respective target contour and the reference contour.
(viii). By using the target contour instead of the actual contour, the generated PSD data possesses reduced artifacts caused by the transformation, which, when being used for the estimating of edge roughness, enables deriving roughness parameters with higher accuracy.
(ix). The PSD data can comprise noise data representative of segmentation noise induced by contour extraction in the set of images.
(x). The processing circuitry can be further configured to fit a noise model, together with a roughness model, to the PSD data to predict the noise data, and remove the predicted noise data from the PSD data, to obtain denoised PSD data.
(xi). The feature can be in a shape of a 2D polygon. The noise model can represent a specific noise behavior of the 2D polygon characterized by a plateau, followed by a slope in a high-frequency range of the PSD data.
(xii). The noise model can be based on an auto-correlation function of the segmentation noise.
(xiii). The processing circuitry can be further configured to estimate edge roughness of the feature by analyzing the denoised PSD data to derive one or more roughness parameters representing state of edge roughness of the feature.
(xiv). The noise model can be defined as Fourier transform of a sum of a series of auto-correlation functions of the segmentation noise, the series including at least auto-correlation functions with a lag of zero, one and two respectively representing auto-correlation of segmentation noises induced when a pixel spans at least one, two, and three strips.

In accordance with other aspects of the presently disclosed subject matter, there is provided a computerized method of estimating edge roughness of a feature on a semiconductor specimen, the method comprising: obtaining a set of images capturing the feature and design data of the feature; providing, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and generating power spectral density (PSD) data based on edge placement difference (EPD) between each target contour in the set of target contours and the reference contour, wherein the PSD data is usable for estimating edge roughness of the feature.

These aspects of the disclosed subject matter can comprise one or more of features (i) to (xiv) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of estimating edge roughness of a feature on a semiconductor specimen, the method comprising: obtaining a set of images capturing the feature and design data of the feature; providing, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and generating power spectral density (PSD) data based on edge placement difference (EPD) between each target contour in the set of target contours and the reference contour, wherein the PSD data is usable for estimating edge roughness of the feature.

This aspect of the disclosed subject matter can comprise one or more of features (i) to (xiv) listed above with respect to the system, mutatis mutandis, in any desired combination or permutation which is technically possible.

In accordance with further aspects of the presently disclosed subject matter, there is provided a computerized system of denoised roughness estimation for a feature in a semiconductor specimen, the system comprising a processing circuitry configured to obtain, based on a set of images of the feature, power spectral density (PSD) data characterizing edge roughness of the feature, wherein the feature has a two-dimensional (2D) pattern, and the PSD data comprises noise data representative of segmentation noise induced during contour extraction in the set of images; fit a noise model, together with a roughness model, to the PSD data to predict the noise data, the noise model representing a specific noise behavior of the 2D pattern characterized by a plateau, followed by a slope in a high-frequency range of the PSD data; and remove the predicted noise data from the PSD data, to obtain denoised PSD data, wherein the denoised PSD data is usable for estimating denoised edge roughness of the feature.

In addition to the above features, the system according to this aspect of the presently disclosed subject matter can comprise one or more of features (xv) to (xxiv) listed below, in any desired combination or permutation which is technically possible:
(xv). The specific noise behavior can be caused by auto-correlation of the segmentation noise in cases where one pixel in a given image of the set of images impacts identification of two or more contour points of an actual contour of the feature in the given image.
(xvi). The actual contour of the feature can be extracted by identifying a plurality of contour points in the given image corresponding to a plurality of reference points from a reference contour obtained from design data of the feature. The plurality of contour points constitutes the actual contour.
(xvii). The plurality of contour points can be identified by aligning the given image with the reference contour; placing a plurality of strips respectively at locations of the plurality of reference points, each strip extending in a direction perpendicular to the reference contour; and obtaining, from each strip, a respective contour point based on gray level intensities along the strip. The specific noise behavior is caused in cases of one pixel spanning two or more strips of the plurality of strips.
(xviii). The noise model can be based on an auto-correlation function of the segmentation noise.
(xix). The noise model can be defined as Fourier transform of a sum of a series of auto-correlation functions of the segmentation noise, the series comprising at least auto-correlation functions with a lag of zero, one and two respectively representing auto-correlation of the segmentation noise induced when a pixel spans at least one, two, and three strips.
(xx). Using the noise model enables to sufficiently remove the segmentation noise from the PSD data and allow accurate estimation of edge roughness.
(xxi). The PSD data can be obtained based on edge placement difference (EPD) between a set of target contours from the set of images and the reference contour. A given target contour from the set of target contours can be obtained by correcting an actual contour of the feature extracted from a given image, with respect to a transformation between the actual contour and a reference contour of the feature obtained from the design data.
(xxii). The noise model can be based on a Lorentzian function.
(xxiii). The 2D pattern is a 2D polygon with an arbitrary shape.
(xxiv). The roughness model can be based on a Lorentzian function.

In accordance with further aspects of the presently disclosed subject matter, there is provided a computerized method of denoised roughness estimation for a feature in a semiconductor specimen, the method comprising: obtaining, based on a set of images of the feature, power spectral density (PSD) data characterizing edge roughness of the feature, wherein the feature has a two-dimensional (2D) pattern, and the PSD data comprises noise data representative of segmentation noise induced during contour extraction in the set of images; fitting a noise model, together with a roughness model, to the PSD data to predict the noise data, the noise model representing a specific noise behavior of the 2D pattern characterized by a plateau followed by a slope in a high-frequency range of the PSD data; and removing the predicted noise data from the PSD data, to obtain denoised PSD data, wherein the denoised PSD data is usable for estimating denoised edge roughness of the feature.

These aspects of the disclosed subject matter can comprise one or more of features (xv) to (xxiv) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of denoised roughness estimation for a feature in a semiconductor specimen, the method comprising: obtaining, based on a set of images of the feature, power spectral density (PSD) data characterizing edge roughness of the feature, wherein the feature has a two-dimensional (2D) pattern, and the PSD data comprises noise data representative of segmentation noise induced during contour extraction in the set of images; fitting a noise model, together with a roughness model, to the PSD data to predict the noise data, the noise model representing a specific noise behavior of the 2D pattern characterized by a plateau, followed by a slope in a high-frequency range of the PSD data; and removing the predicted noise data from the PSD data, to obtain denoised PSD data, wherein the denoised PSD data is usable for estimating denoised edge roughness of the feature.

This aspect of the disclosed subject matter can comprise one or more of features (xv) to (xxiv) listed above with respect to the system, mutatis mutandis, in any desired combination or permutation which is technically possible.

### BRIEF DESCRIPTION OF THE DRAWINGS

The accompanying drawings illustrate implementations of the concepts conveyed in the present disclosure. In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of roughness estimation for a feature in a semiconductor specimen in accordance with certain embodiments of the presently disclosed subject matter.

FIG. 3 illustrates a generalized flowchart of denoising the PSD in accordance with certain embodiments of the presently disclosed subject matter.

FIG. 4 shows a generalized flowchart of correcting an actual contour to provide a target contour in accordance with certain embodiments of the presently disclosed subject matter.

FIG. 5 shows an exemplary flowchart of identifying image points on a given image corresponding to reference points in accordance with certain embodiments of the presently disclosed subject matter.

FIG. 6 shows a schematic illustration of a PSD plot corresponding to a line structure in accordance with certain embodiments of the presently disclosed subject matter.

FIG. 7 is a schematic illustration of an example of a 2D feature and its reference and actual edges in accordance with certain embodiments of the presently disclosed subject matter.

FIG. 8 is a schematic illustration of an example of a 2D feature with certain transformation in accordance with certain embodiments of the presently disclosed subject matter.

FIG. 9 illustrates an example of identifying a plurality of pairs of corresponding points in accordance with certain embodiments of the presently disclosed subject matter.

FIG. 10 shows a schematic illustration of applying affine transformation to obtain a corrected contour in accordance with certain embodiments of the presently disclosed subject matter.

FIG. 11 illustrates a comparison between a PSD generated based on the actual contour, without correcting the transformation, and a PSD generated based on the target contour, after correcting the transformation in accordance with certain embodiments of the presently disclosed subject matter.

FIG. 12 illustrates an example of a 1D feature and a 2D feature and the PSD data generated therefor in accordance with certain embodiments of the presently disclosed subject matter.

FIG. 13 is a schematic illustration of one pixel impacting contour extraction in two or more contour points in accordance with certain embodiments of the presently disclosed subject matter.

FIG. 14 shows a comparison between PSD data of a 2D feature fitted respectively with a white noise model and a correlation-based noise model in accordance with certain embodiments of the presently disclosed subject matter.

### DETAILED DESCRIPTION OF EMBODIMENTS

As described above, edge roughness of integrated circuit features refers to non-uniform deviations or variations along the edges of the features. Edge roughness may occur due to variations in the manufacturing process or subsequent handling of a semiconductor device. For instance, various steps in the semiconductor fabrication process, such as lithography, etching, or deposition, etc., can introduce edge roughness due to factors such as mask alignment errors, material non-uniformity, or chemical reactions at the edges, etc. In some cases, edge roughness may directly impact device functionalities and potentially lead to yield loss, in particular with respect to the continuous advancement of technology and reduction of feature sizes. Various techniques and metrics have been developed to characterize roughness of an integrated circuit feature.

Power Spectral Density (PSD) is a frequency domain analysis technique that can be used to characterize feature roughness. PSD generally refers to a measure of how the power of a signal is distributed across different frequencies. In the context of roughness estimation, PSD can be used to provide information on the spatial frequencies present in an edge profile.

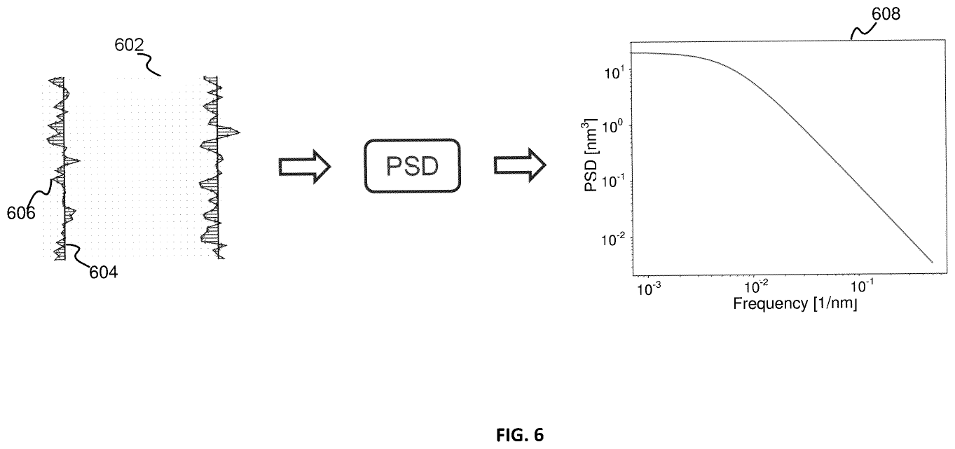

FIG. 6 shows a schematic illustration of a PSD plot corresponding to a line structure in accordance with certain embodiments of the presently disclosed subject matter.

A vertical line structure 602 is exemplified with a left edge and a right edge. Taking the left edge for example, a centered straight line 604 represents a reference edge (also referred to as reference contour) defined according to design data of the line structure. The wavy line 606 represents an actual rough edge (also referred to as actual contour) of the line structure resulting from the manufacturing process. The roughness of the actual edge is represented as non-uniformed variations/deviations which are induced by process variations. As illustrated, the actual rough edge 606 deviates from the reference edge 604 with different amounts of displacements along the vertical direction. Such deviation can be represented in the frequency domain using PSD, representing the variance of the edge per unit frequency.

Plot 608 illustrates an exemplified expected PSD curve. The X-axis represents spatial frequency (1/nm) and indicates how quickly the rough edge profile changes along the vertical direction. For instance, low frequencies correspond to large-scale variations (i.e., edge variations occurring over longer length scale), while high frequencies correspond to small-scale variations (i.e., edge variations occurring over shorter length scale). The Y-axis represents the power at each spatial frequency, and indicates how much of the edge's roughness is attributed to a particular scale of the feature.

The PSD curve in plot 608 represents an expected shape of a PSD generated for edge roughness of a semiconductor feature. At low frequencies, the PSD curve is relatively flat. This region corresponds to large-scale variations (e.g., variations over longer distance) or low-frequency undulations along the edge of the semiconductor feature. As edge points that are distant from each other tend to be less correlated with one other, the PSD curve in this region typically represents uncorrelated noise that has a flat power spectral density.

When the frequency increases to a certain range, the PSD curve typically shows a rapid decrease or roll-off, reflecting the fact that when edge points along the edge are getting closer, edge variations become more correlated. This region corresponds to small-scale features or high-frequency oscillations along the edge, which may result from fine-scale interactions or fluctuations during the lithography or etching process.

The transition between these two regions relates to correlation length. Correlation length is a measure of how quickly the roughness fluctuations decorrelate as a function of distance along the edge. It indicates the characteristic length scale over which edge roughness features exhibit correlation. A shorter correlation length implies that roughness features change rapidly along the edge, while a longer correlation length suggests more gradual changes. In PSD, the correlation length can be estimated from the inverse of the frequency at which the PSD drops significantly.

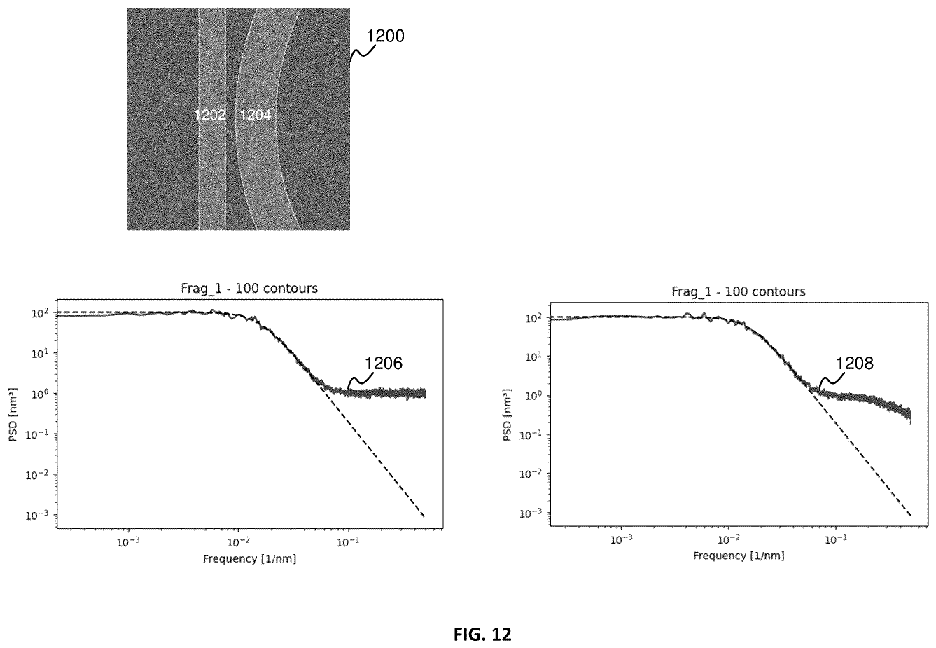

At high frequencies, a PSD curve would typically flatten out (not illustrated in plot 608). This flattened region, as illustrated below in PSD 1206 of FIG. 12, indicates the level of uncorrelated noise present in the roughness measurements, which may arise from, e.g., segmentation noises, etc., as will be detailed further below.

Despite the wide adaptation of PSD for characterizing process induced variations, roughness estimation is currently limited to the cases of one dimensional (1D) features, such as pure vertical and/or horizontal lines. In cases of two dimensional (2D) features, such as polygons with any arbitrary shape, the PSD analysis as described above is no longer applicable.

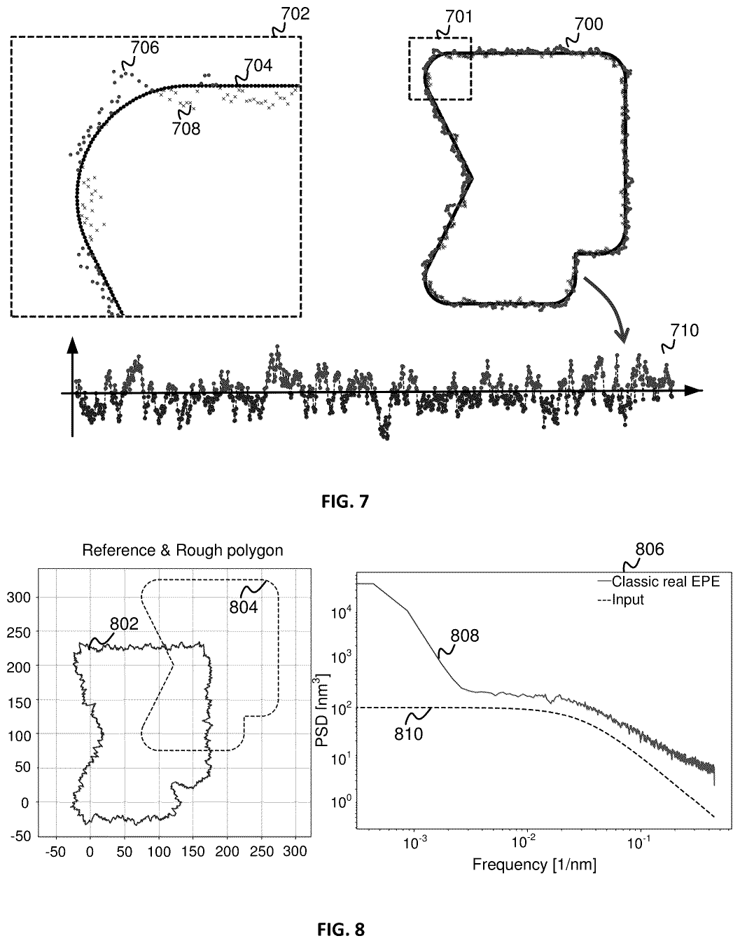

FIG. 7 illustrates an example of a 2D feature and its reference and actual edges in accordance with certain embodiments of the presently disclosed subject matter.

The feature 700 is a 2D pattern with an arbitrary shape. For purpose of better illustration, a magnified view 702 of a part 701 of feature 700 is shown. Similarly, a reference edge/contour 704 and an actual edge/contour of the feature 700 are obtained. As shown in view 702, some of the edge points 706 on the actual edge fall outside of the reference edge 704, while some of the edge points 708 fall within the reference edge 704. Edge placement difference (EPD), or edge displacements, between the reference edge and the actual edge can be represented as signed distances between corresponding points on the reference and actual edges. The respective signs depend on the position of the points on the actual edge relative to the reference edge. For instance, the EPD of the points 706 can be regarded as positive distances, while the EPD of the points 708 can be regarded as negative distances.

The signed EPDs along the actual edge can be plotted in an X-Y axis as represented in 710, where the X axis represents the locations of the points along the edge/contour, and the Y axis represents the corresponding signed EPDs.

In the above example of FIG. 7, the reference edge and the actual edge of the 2D feature are perfectly matched/aligned. However, in the actual manufacturing process, due to process variations, the resulting 2D feature on the semiconductor specimen may oftentimes possess certain geometric transformations, such as, e.g., translations, rotations, and scaling, with respect to the original design intent. FIG. 8 illustrates an example of a 2D feature with certain transformation in accordance with certain embodiments of the presently disclosed subject matter.

As shown, the actual contour 802 of the 2D feature is shifted from the reference contour 804 (i.e., translation) of the feature. Such translation not only changes the EPD values (such as, e.g., the EPD values of the points 706 and 708) which are calculated based on both X and Y coordinates of the points, but also causes some of the previous EPDs to have opposite signs due to the change of the relative position with respect to the reference contour. When applying PSD using such EPD data, the resulting PSD possesses unwanted artifacts.

As illustrated in the PSD plot 806, the actual resulting PSD 808 not only has an overall shift from the expected PSD 810, but also presents a relatively large artifact at PSD(0), which represents the value of the PSD in the low-frequency region. Using such PSD data with artifacts would result in incorrect estimation of edge roughness, which may possibly mislead the process control and optimization.

In addition, roughness estimation can suffer from various types of noises present in the imaging and/or measurement processes. These noises add to the actual roughness of the patterns, distort the measured roughness values, thus undesirably leading to inaccuracies and biases in the results. Therefore, it is crucial to denoise the PSD data in roughness measurement so as to provide a more accurate and reliable representation of the feature's true roughness, which impacts process control in semiconductor manufacturing.

However, it is challenging to separate the noises from the true roughness, due to the difficulties in identifying the sources of noises contributing to distortion in roughness measurements and understanding the nature of each noise, especially when multiple noises are present simultaneously. Accurately characterizing the properties of different types of noises, such as its frequency distribution, amplitude, and correlation properties, is essential for selecting appropriate denoising techniques, for effective removal while preserving important features of the PSD.

As semiconductor fabrication processes continue to advance, semiconductor devices are developed with increasingly complex structures with shrinking feature dimensions. The negative effects of roughness of the features become more pronounced, which has increased the desired sensitivity and accuracy of roughness estimation in semiconductor processing so as to provide satisfying examination performance.

Accordingly, certain embodiments of the presently disclosed subject matter propose a roughness estimation system, which does not have one or more of the disadvantages described above. The present disclosure proposes to generate accurate PSD data for a 2D feature without artifacts (or with reduced artifacts), by first calculating any transformation between an actual contour outlining the feature in the images, and a reference contour from the original design layout of the feature, and correcting the actual contour with respect to the calculated transformation. PSD is only generated after such correction, based on the corrected feature contour, so as to reduce the presence of artifacts caused by the transformation. The present disclosure also provides a denoising system and method for effectively removing noise data representative of segmentation noise from the PSD data, using a specific noise model designed to fit the specific noise behavior of 2D feature, as will be detailed below.

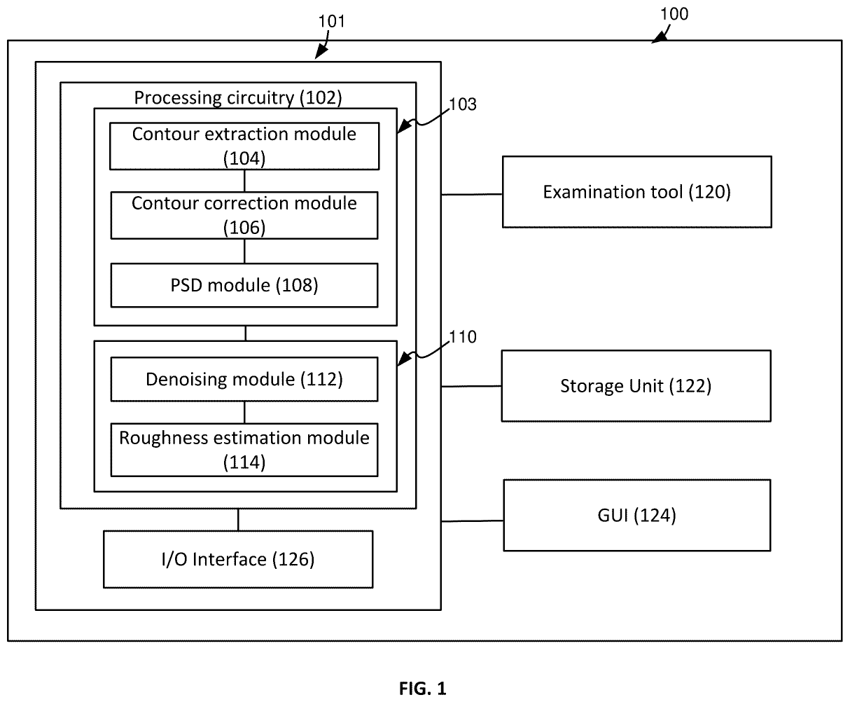

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication/manufacturing process. The process of semiconductor manufacturing often requires multiple sequential processing steps and/or layers, some of which could possibly cause errors that may lead to yield loss. Examples of various processing steps can include lithography, etching, depositing, planarization, growth (such as, e.g., epitaxial growth), and implantation, etc. The examination system 100 can be configured to perform various examination operations, such as defect-related examination (e.g., defect detection, defect review, and defect classification, etc.), and/or metrology-related examination (e.g., critical dimension (CD) measurements, etc.), at different processing steps/layers during the manufacturing process, to monitor and control the process. The examination operations can be performed a multiplicity of times, for example after certain processing steps, and/or after the manufacturing of certain layers, or the like.

System 100 comprises one or more examination tools configured to scan a specimen and capture images thereof to be further processed for various examination applications. The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof.

Without limiting the scope of the disclosure in any way, it should also be noted that the examination tools can be implemented as inspection machines of various types, such as optical inspection machines, electron beam inspection machines (e.g., a Scanning Electron Microscope (SEM), an Atomic Force Microscopy (AFM), or a Transmission Electron Microscope (TEM), etc.), and so on.

By way of example, a scanning electron microscope (SEM) is a type of electron microscope that produces images of a specimen by scanning the specimen with a focused beam of electrons. An SEM is capable of accurately inspecting and measuring features during the manufacture of semiconductor wafers. The electrons interact with atoms in the specimen, producing various signals that contain information on the surface topography and/or composition of the specimen. By way of example, the SEM tool can be critical dimension scanning electron microscopes (CD-SEM) used to measure critical dimensions of structural features in the images.

In some cases, at least one of the examination tools 120 has metrology capabilities and can be configured to capture images and perform metrology operations on the captured images. Such an examination tool is also referred to as a metrology tool. Additionally or alternatively, the one or more examination tools 120 can include one or more inspection tools configured to scan a specimen (e.g., an entire wafer, or an entire die) to capture inspection images (typically, at a relatively high-speed and/or low-resolution) for detection of potential defects (i.e., defect candidates), and/or one or more review tools configured to capture review images of at least some of the defect candidates detected by the inspection tools for ascertaining whether a defect candidate is indeed a defect of interest (DOI).

The present disclosure is not limited to any specific type of examination tools and/or the type or resolution of image data resulting from the examination tools.

According to certain embodiments of the presently disclosed subject matter, the examination system 100 comprises a computer-based system 101 operatively connected to the examination tool 120, and capable of automatic roughness estimation for a feature in a semiconductor specimen. System 101 is also referred to as a roughness estimation system.

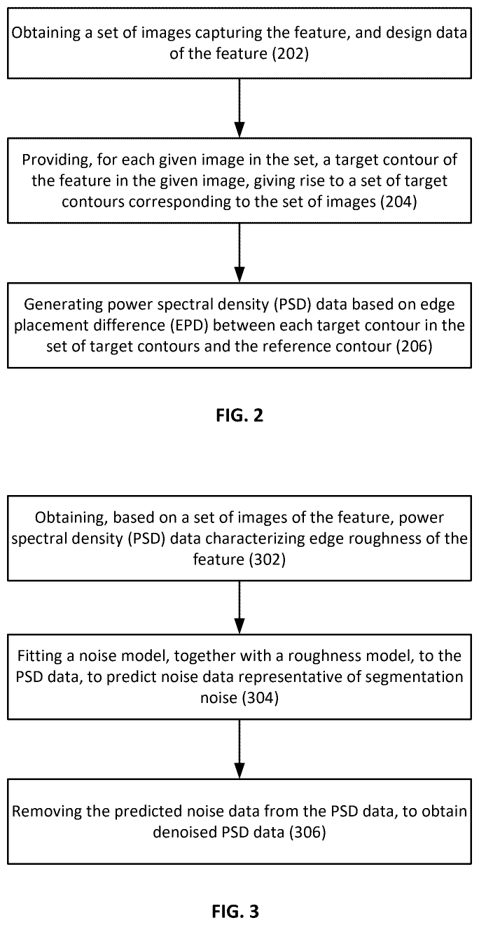

System 101 includes a processing circuitry 102 operatively connected to a hardware-based I/O interface 126 and configured to provide processing necessary for operating the system, as further detailed with reference to FIGS. 2-5. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

According to certain embodiments, system 101 can be regarded as comprising two sub-systems respectively configured for performing PSD estimation and denoising of the PSD. Accordingly, the processing circuitry 102 of system 101 can be regarded as comprising two processing components 103 and 110 corresponding to the two sub-systems. The first component 103 is directed to PSD estimation, and one or more functional modules comprised therein can include a contour extraction module 104, a contour correction module 106, and a PSD module 108. The second component 110 is directed to denoising of the generated PSD, and one or more functional modules comprised therein can include a denoising module 112, and a roughness estimation module 114.

Specifically, the processing component 103 can be configured to obtain, via an I/O interface 126, a set of images capturing a feature on a semiconductor specimen, and design data of the feature. The contour extraction module 104 can be configured to extract a reference contour of the feature from the design data, and extract, for each given image in the set of images, an actual contour of the feature from the given image. The contour correction module 106 can be configured to provide, for each given image, a target contour of the feature in the given image by correcting the actual contour of the feature with respect to a transformation between the actual contour and the reference contour of the feature, giving rise to a set of target contours corresponding to the set of images. The PSD module 108 can be configured to generate PSD data based on edge placement difference (EPD) between each target contour in the set of target contours and the reference contour. The generated PSD data includes noise data representative of segmentation noise induced during contour extraction in the set of images, and can be passed on to processing component 110 for further processing.

In some embodiments, upon receiving the PSD data from processing component 103, the denoising module 112 in processing component 110 can be configured to fit a noise model, together with a roughness model, to the PSD data, to predict noise data representative of the segmentation noise. The noise model represents a specific noise signature/behavior characterized by a plateau and a slope (the slope following the plateau) in a high-frequency range of the PSD data. The roughness estimation module 114 can be configured to remove the predicted noise data from the PSD data, to obtain denoised PSD data. The denoised PSD data is usable for estimating denoised edge roughness of the feature.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules can thus be performed by respective processors (or processor combinations) in the processing circuitry 102, while, optionally, these operations may be performed by the same processor. For instance, in some cases, operation(s) of the functional modules in component 103 may be performed by a processor, while operation(s) of the functional modules in component 110 may be performed by a different processor. In some other cases, operation(s) of the functional modules in processing circuitry 102 may be performed by the same processor (or processor combinations). The present disclosure should not be limited to being construed as one single processor always performing all the operations of the processing circuitry, or all the operations of a processing component.

In some cases, additionally to system 101, the examination system 100 can comprise one or more examination modules, such as, e.g., defect detection module, nuisance filtration module, Automatic Defect Review Module (ADR), Automatic Defect Classification Module (ADC), metrology operation module, and/or other examination modules which are usable for examination of a semiconductor specimen. The one or more examination modules can be implemented as stand-alone computers, or their functionalities (or at least part thereof) can be integrated with the examination tool 120. In some cases, the output of system 101, e.g., the PSD data, the noise data, the roughness estimation, etc., can be provided to the one or more examination modules for further processing.

In some cases, the functional modules in system 101 can be regarded as part of an examination recipe usable for performing runtime examination operations on acquired runtime images of semiconductor specimens.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store the set of images and/or derivatives thereof produced by the examination tool 120, and the design data of the feature, etc., as described above. Accordingly, the different types of input data as required can be retrieved from the storage unit 122 and provided to the processing circuitry 102 for further processing. The output of the system 101, such as, e.g., the PSD data, the noise data, the roughness estimation, etc., can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the feature or the specimen (for example, by a display forming part of GUI 124), including the images, the design layout, etc. The user may be provided, through the GUI, with options of defining certain operation parameters. The user may also view the operation results or intermediate processing results, such as, e.g., the PSD data, the noise data, the roughness estimation, etc., on the GUI.

In some cases, system 101 can be further configured to send, via I/O interface 126, the operation results to the examination tool 120 for further processing. In some cases, system 101 can be further configured to send the results to the storage unit 122, and/or external systems (e.g., Yield Management System (YMS) of a fabrication plant (Fab)). A yield management system (YMS) in the context of semiconductor manufacturing is a data management, analysis, and tool system that collects data from the fab, especially during manufacturing ramp ups, and helps engineers find ways to improve yield. YMS helps semiconductor manufacturers and fabs manage high volumes of production analysis with fewer engineers. These systems analyze the yield data and generate reports. YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tool 120 and the system 101 can be located at the same entity (in some cases hosted by the same device) or distributed over different entities. By way of another example, in some cases, the two sub-systems in system 101, or the two processing components 103 and 110, can be integrated together and located at the same entity (in some cases hosted by the same device). Alternatively, they can be implemented separately and distributed over different entities, depending on specific system configurations and implementation needs.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It should be further noted that in some embodiments at least some of examination tool 120, storage unit 122 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tool(s) 120, thereby facilitating and enhancing the functionalities of the examination tools in examination-related processes.

While not necessarily so, the process of operations of systems 101 and 100 can correspond to some or all of the stages of the methods described with respect to FIGS. 2-5. Likewise, the methods described with respect to FIGS. 2-5 and their possible implementations can be implemented by systems 101 and 100. It is therefore noted that embodiments discussed in relation to the methods described with respect to FIGS. 2-5 can also be implemented, mutatis mutandis, as various embodiments of the systems 101 and 100, and vice versa.

Referring to FIG. 2, there is illustrated a generalized flowchart of roughness estimation for a feature in a semiconductor specimen in accordance with certain embodiments of the presently disclosed subject matter.

As described above, a semiconductor specimen is typically made of multiple layers. The examination process of a specimen can be performed a multiplicity of times during the fabrication process of the specimen, for example following the processing steps of specific layers. In some cases, a sampled set of processing steps can be selected for in-line examination, based on their known impacts on device characteristics or yield. Images of the specimen or parts thereof can be acquired at the sampled set of processing steps to be examined.

For the purpose of illustration only, certain embodiments of the following description are described with respect to images of a given processing step/layer of the sampled set of processing steps. Those skilled in the art will readily appreciate that the teachings of the presently disclosed subject matter, such as the process of PSD estimation, and/or the process of denoising as described below, can be performed following any layer and/or processing steps of the specimen. The present disclosure should not be limited to the number of layers comprised in the specimen and/or the specific layer(s) to be examined.

A set of images capturing a feature on a semiconductor specimen, as well as design data of the feature, can be obtained (202). A semiconductor specimen can refer to a semiconductor wafer, a die, or parts thereof, that is fabricated and examined in the fab during a fabrication process thereof. A feature used herein refers to a target structure that is of interest to be examined on the semiconductor specimen. The feature (also referred to as a target feature) can be a structural element/pattern that represents at least a part of an electronic circuit. By way of example, the target feature may represent part of a transistor, a capacitor, a resistor, an electronic interconnect, a logic gate, and/or other circuits, or a combination thereof. In some cases, a target feature can also be defined by the spacing between certain structures.

In some cases, the target feature referred to herein can be in the shape of a line that extends primarily along a single dimension, typically with a constant width. Such a line feature is also referred to herein as a 1D feature, and can be represented by a straight line or a linear segment. The 1D feature can be generally characterized by its elongated shape along one primary direction, with minimal variation in width perpendicular to the primary direction. An example of a 1D feature is the vertical line structure 602 in FIG. 6.

In some other cases, the target feature can be in the shape of a two-dimensional (2D) polygon. Such a feature is also referred to herein as a 2D feature. A 2D feature may exhibit variations in both length and width (and possibly multiple dimensions), and can have a more complex or irregular geometry with any arbitrary shape. An example of a 2D feature with an arbitrary shape is illustrated in FIG. 7 as the feature 700. By way of example, 2D features may represent structural features such as, e.g., contacts, vias, transistors, or photonic structures on a semiconductor wafer, which may have irregular shapes and dimensions varying in multiple directions.

In some embodiments, a target feature typically has repetitive presence/appearances on the specimen. By way of example, the specimen may comprise a plurality of sites/regions, each containing an instance of the feature. A set of images can be sequentially acquired by an examination tool capturing the plurality of sites. For purpose of accurate assessment, edge roughness is typically measured over multiple instances of a feature to obtain a statistical representation of the roughness (e.g., by analyzing the set of images capturing the multiple instances of the feature), so as to assess the uniformity and quality of the fabrication process.

In addition to the set of images, design data that represents the physical design layout of the feature can be obtained, e.g., from the storage unit 122 or a design server, as part of the input to the system 101. The design data can be used as reference data for estimating edge roughness, as described below in further detail.

For each given image in the set of images, a target contour of the feature in the given image can be provided (204), giving rise to a set of target contours corresponding to the set of images. The target contour can be obtained by correcting (e.g., by the contour correction module 106) an actual contour of the feature extracted from the given image, with respect to a transformation between the actual contour and a reference contour of the feature obtained from the design data.

As described above with reference to FIG. 8, due to process variations in the manufacturing process, certain features on the semiconductor specimen may possess transformations, such as, e.g., translations, rotations, and scaling, with respect to the original design intent. In particular, for 2D features, such transformation unavoidably changes the signs and values of the EPD values representative of edge roughness, resulting in PSD with unwanted artifacts.

In order to generate PSD without such artifacts, the present disclosure proposes to first calculate any transformation between an actual contour of the feature as reflected in the images, and a reference contour of feature from the original design layout of the feature, and correct the actual contour with respect to the calculated transformation. PSD is only generated after such correction, based on the corrected feature contour.

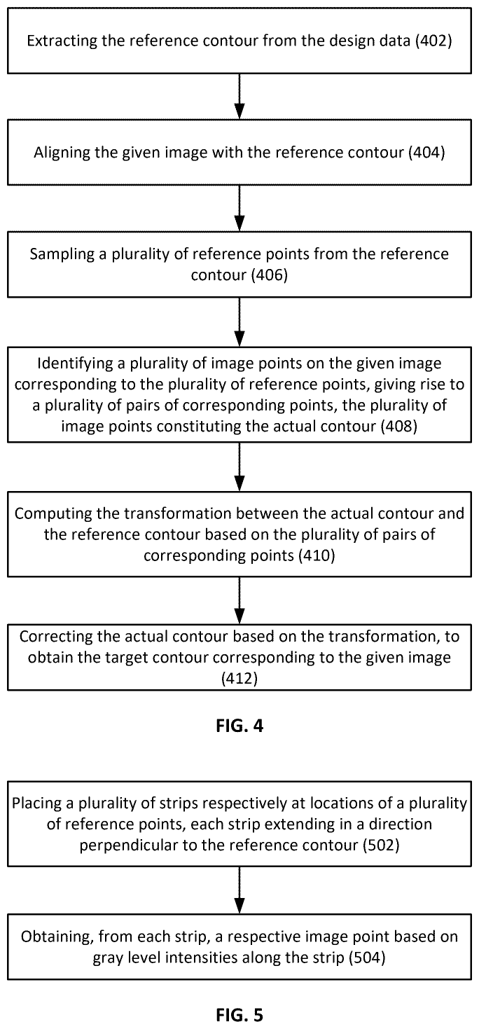

Specifically, the transformation can be derived between an actual contour of the feature extracted from a given image and a reference contour of the feature obtained from the design data, as described below with reference to FIG. 4.

Referring now to FIG. 4, there is illustrated a generalized flowchart of correcting an actual contour to provide a target contour in accordance with certain embodiments of the presently disclosed subject matter.

A reference contour of the feature can be extracted (402) from the design data. The reference contour can be extracted based on the original design layout of the feature. In some cases, optionally, simulation can be performed on the design data, to imitate the physical effects caused by the fabrication process. The simulated output represents how the design patterns in the design layout would actually appear on the wafer. In other words, the simulation transfers the design intent layout to the expected processed pattern on the wafer. Such simulation is also referred as stepper simulation, and can be performed, e.g., by convolving the design data (e.g., in the form of rasterized CAD) with a stepper beam shape filter. In such cases, the reference contour can be extracted after the simulation, based on the simulated output. In some cases, the reference contour extraction and/or simulation can be performed beforehand, as a preliminary process prior to the processing of the present disclosure.

A given image from the set of images can be aligned (404) with the reference contour. The alignment/matching between the image and the reference contour can be performed using various image registration techniques for purpose of correcting an offset between the two. For instance, through registration it can be determined how the image should be shifted with an offset to correspond to the reference contour.

Various approaches can be used to extract an actual contour of the feature from the given image, including but not limited to, e.g., techniques based on edge detection, image segmentation, etc., which can be possibly applicable to the present disclosure for deriving the actual contour of the feature. Certain embodiments of the present disclosure propose a unique way of contour extraction based on the reference contour as described below.

A plurality of reference points can be sampled (406) from the reference contour. By way of example, the reference points can be sampled evenly along the reference contour, such as, e.g., one reference point per pixel or part of a pixel. A plurality of image points (also referred to as contour points) can be identified (408) on the given image to correspond to the plurality of reference points, giving rise to a plurality of pairs of corresponding points.

FIG. 5 illustrates an exemplary flowchart of identifying image points on a given image corresponding to reference points in accordance with certain embodiments of the presently disclosed subject matter. By way of example, the plurality of image points can be identified by placing (502) a plurality of strips respectively at locations of the plurality of reference points, each strip extending in a direction perpendicular to the reference contour, and obtaining (504), from each strip, a respective image point based on gray level intensities along the strip. The plurality of image points constitutes the actual contour of the feature from the given image.

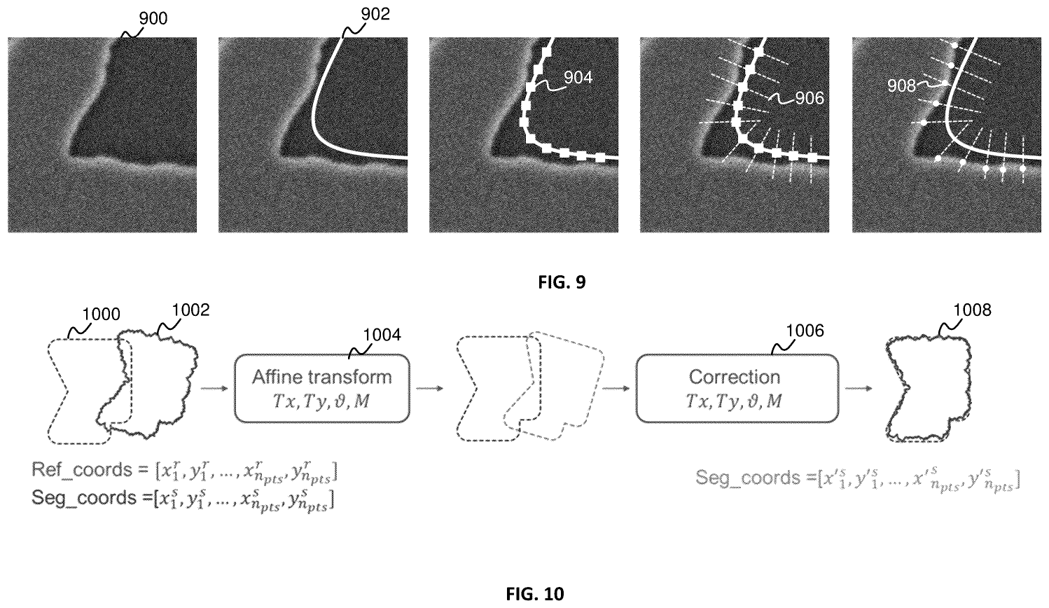

FIG. 9 illustrates an example of identifying a plurality of pairs of corresponding points in accordance with certain embodiments of the presently disclosed subject matter.

As shown, a SEM image 900 capturing a part of a feature is obtained. After registration, the SEM image 900 is aligned with a reference contour 902 of the feature. Multiple reference points 904 are evenly sampled along the reference contour 902, with the same spacing. At the location of each given reference point, a strip (illustrated as dashed lines across the reference contour) is placed in a direction perpendicular to the reference contour 902. An image point can be identified along the strip, as a corresponding point to the reference point. The image point can be identified based on the gray level values of the pixels along the strip. By way of example, for the specific reference point 904, a strip 906 is placed across the reference contour. A gray level waveform can be derived based on the gray level values of pixels along the strip 906. An image point 908 that has the largest derivative along the waveform (or any other suitable measure based on the GL values) can be identified as the corresponding image point of reference point 904. The image point 908 and the reference point 904 form a pair of corresponding points. Similarly, multiple image points can be identified, corresponding to the multiple reference points sampled along the reference contour, forming multiple pairs of corresponding points, as exemplified in FIG. 9. The multiple image points form the actual contour of the feature from the SEM image 900.

As mentioned above, other ways of contour or key points extraction methods can be possibly used. By way of example, the SEM image can be segmented using an image segmentation algorithm, to extract the actual contour of the feature, irrespective of the reference contour. In some cases, the image segmentation can be possibly based on machine learning, such as, e.g., by using a deep segmentation network. The actual contour and the reference contour can be then matched/aligned, and key points can be extracted from the contours to form the pairs of points usable for transformation.

As compared to other image segmentation or contour extraction methods, the above proposed solution with reference to FIGS. 4 and 9 has the advantage of obtaining multiple pairs of points that are evenly distributed in space along the contours, which is advantageous for correcting affine transformation, and is a pre-requisite for computing PSD. It results in more accurate correction and reduction of artifacts in the generated PSD data.

Continuing with the description of FIG. 4, the transformation between the actual contour and the reference contour can be computed (410) based on the plurality of pairs of corresponding points. The actual contour can be corrected (412) based on the transformation, to obtain the target contour corresponding to the given image. In some cases, the transformation can be represented as a geometric transformation, such as, e.g., affine transformation. An affine transformation is a linear mapping method that transforms points from one coordinate system to another while preserving points, straight lines, and planes. Examples of an affine transformation can include translation, scaling, rotation, reflection, and compositions of the above in any combination and sequence.

Referring now to FIG. 10, assume n pairs of points are identified and represented by their respective coordinates as follows: Ref_coords=[x₁^{r}, y₁^{r}, . . . , xₙ^{r}, yₙ^{r}], representing the coordinates of the n reference points from a reference contour 1000, and Seg_coords=[x₁^{s}, y₁^{s}, . . . , xₙ^{s}, yₙ^{s}], representing the coordinates of the n image points from an actual contour 1002 of an SEM image. The affine transformation can be computed based on the two sets of coordinates. The affine transformation can be defined by a set of equations or a transformation matrix, to derive the affine transformation parameters 1004 (e.g., Tx and Ty that represent the x and y offsets, θ representing the rotation angle, and M representing a scaling factor) that define the translation, rotation, and scaling between the two set of coordinates.

A correction can be applied to the coordinates (Seg_coords=[x₁^{s}, y₁^{s}, . . . , xₙ^{s}, yₙ^{s}]) of the n image points from the actual contour 1002 based on the transformation parameters. The corrected coordinates Seg_coords=[x′₁^{s}, y′₁^{s}, . . . , x′ₙ^{s}, y′ₙ^{s}] form a corrected contour 1008 of the actual contour 1002, where the translation, rotation and scaling are fixed. The corrected contour 1008 closely matches the reference contour 1000, and is also referred to as the target contour for the feature in the SEM image.

Referring back to FIG. 2, as described with reference to block 204, once the target contour (i.e., corrected contour) for each image in the set of images is obtained, in a similar manner as described above with reference to FIG. 4, power spectral density (PSD) data can be generated (206) (e.g., by the PSD module 108) based on edge placement difference (EPD) between each target contour in the set of target contours and the reference contour. The PSD data is usable for estimating edge roughness of the feature.

The EPD between a target contour and the reference contour can be represented as signed distances between corresponding points on the two contours. The corresponding points refer to corresponding reference points from the reference contour and corrected image points from the target contour. For instance, for a pair of points 904 and 908 as exemplified in FIG. 9, the image point 908 is corrected based on the transformation 1006 illustrated in FIG. 10, giving rise to a corrected image point (not illustrated in FIG. 9). The corrected image point and the reference point 904 form a pair of corresponding points on the target contour and the reference contour. An EPD value can be calculated between the two corresponding points. Similarly, EPD values can be calculated between multiple corresponding points on a given target contour and the reference contour. An individual PSD data can be generated based on the EPD values of the multiple corresponding points on the given target contour and the reference contour.

For a set of images and a set of target contours thereof, a set of individual PSD data can be generated, each corresponding to EPD between a respective target contour and the reference contour. As described above, edge roughness is a statistical roughness representation. Therefore, an overall PSD data (also referred to as PSD data) can be obtained by averaging (using any type of averaging measures) among the set of individual PSD data corresponding to the set of images.

By using the target contour instead of the actual contour, the generated PSD data possesses reduced artifacts caused by the transformation, due to process variations. Such PSD data, when being used for estimating edge roughness, enables deriving roughness parameters with higher accuracy.

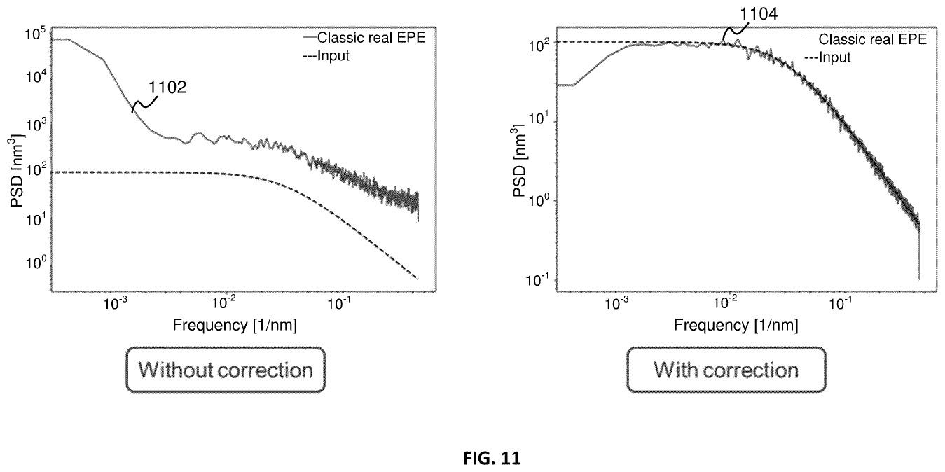

FIG. 11 illustrates a comparison between a PSD 1102 generated based on the actual contour, without correcting the transformation, and a PSD 1104 generated based on the target contour, after correcting the transformation in accordance with certain embodiments of the presently disclosed subject matter. As shown, PSD 1102 shows an overall deviation from the expected PSD (illustrated by dashed line), with a relatively large artifact at PSD(0), while PSD 1104 is almost fully recovered to match to the expected PSD, attributed to the correction of the transformation using the aforementioned methodology. In particular, using affine transformation correction can greatly improve the PSD recovery.

It is noted that in some cases, PSD 1104 may present a phenomenon of low-frequency underestimation, which may be due to over-alignment between the reference contour and the target contour. In other words, the reference contour and the target contour are actually well matched to each other to such extent that some roughness may be actually lost in the process.

In some embodiments, edge roughness of the feature can be estimated by analyzing the PSD data to derive one or more parameters (e.g., PSD₀, correlation length ξ, H, etc.) representing state/level of edge roughness of the feature.

FIG. 12 illustrates an example of a 1D feature and a 2D feature and the PSD data generated therefor in accordance with certain embodiments of the presently disclosed subject matter.

A SEM image 1200 is illustrated, comprising part of a 1D line feature 1202 and a 2D ring feature 1204. PSD data can be generated respectively for the two features using the presently proposed solution. Specifically, for the 1D line feature 1202, PSD 1206 is generated based on 100 contours extracted from 100 SEM images (including image 1200 as one of the 100 images). The 100 SEM images are acquired from multiple sites on a specimen, where each site contains an instance of feature 1202.

Specifically, a reference contour of feature 1202 is obtained based on the design data of feature 1202. Actual contours are extracted from the 100 SEM images. Affine transformation between the reference contour and actual contours is computed, based on which the actual contours are corrected. PSD 1206 is generated based on the EPD between the corrected contours (i.e., target contours) and the reference contour. It is noted that in the present example, the PSD 1206 as illustrated is generated for the right edge of the line feature 1202. It is appreciated that similar PSD can be generated for the left edge of the feature, and/or for the line width of the feature, which is not illustrated here for purpose of brevity.

Similarly, PSD 1208 is generated for the 2D ring feature 1204 based on the EPD between a corrected contours (i.e., target contours) and the reference contour thereof (e.g., for the right curved edge of the ring feature 1204).

As shown, PSD 1206 is correctly recovered (with respect to the expected PSD illustrated by dashed line) in low and middle frequencies. In high frequency, the expected PSD drastically reduces over short length scales, whereas the PSD 1206 differentiates from the expected PSD in that it flattens out rather than reducing to a minimal level. In other words, a horizontal plateau is present in the high frequency region. The plateau indicates the level of uncorrelated noises (e.g., white noise) present in the roughness measurements, which may arise from noise sources such as segmentation noise, as detailed below.

The term “segmentation” or “image segmentation” refers to partitioning an image into segments representative of various structural features and/or background region in the image. It is used equivalently/interchangeably with contour/boundary extraction of the features in the present disclosure. Segmentation noises refer to segmentation errors resulting from defining the contours/boundaries of a feature in the image. Segmentation noises may add to the actual roughness, thus interfere with the accurate assessment of roughness estimation.

Segmentation noises may arise due to various factors, such as, e.g., image noises, automatic segmentation algorithms, etc. By way of example, when acquiring SEM images, image noises are inherently present in the acquired images, which can significantly impact the quality of the image data. Due to the presence of image noises, segmentation errors are induced when extracting the actual contour of a feature from an SEM image, which affects roughness measurements. SEM image noises may arise from various sources, such as, e.g., detector noises, shot noises, and/or signal variations (e.g., secondary electron (SE) and/or backscattered electron (BSE) signals) due to the interaction of the electron beam with the specimen, especially in cases where the material composition varies.

The generated PSD can thus be regarded as the combination of PSD of roughness (also referred to as roughness PSD) and PSD of segmentation noise (also referred to as segmentation noise PSD).

For 1D features, it can be assumed that correlations in image noises do not create significant correlations in segmentation noises. In such cases, the segmentation noises presented in the PSD can be presumed to be white noise (where the segmentation noise of one pixel of the image is independent of the noise in any other pixel), which is characterized by a constant PSD across frequencies.

As the expected PSD in high frequencies reduces to a minimal level, the plateau of PSD 1206 in the high frequencies can be presumed to represent the level of the white noise. As a combination of roughness PSD and segmentation noise PSD, the roughness PSD in PSD 1206 is represented by the low-frequency plateau and mid-frequency slope, while the segmentation noise PSD is represented by the high-frequency plateau. For purpose of estimating roughness, in some cases, the roughness PSD can be represented by a Lorentzian model (PSD0, H, ξ), while the segmentation noise PSD can be represented by a white noise model (σ). The two models can be fit into the generated PSD as in below equation:

$$P S {D}^{model} ( f ) = \frac{P S {D}_{0}}{1 + {( 2 π f ξ )}^{2 H + 1}} + σ$$

The roughness PSD can be obtained by removing the noise from the generated PSD, as follows:

$$P S {D}^{roughness} ( f ) = P S {D}^{segmentation} ( f ) - σ$$

For the 2D ring feature, the corresponding PSD 1208 is also correctly recovered (with respect to the expected PSD illustrated by dashed line) in low and middle frequencies. However, in high frequency, the PSD 1208 presents a different and more complex noise signature/behavior as compared to the white noise signature in PSD 1206. Specifically, as illustrated, the segmentation noise PSD (i.e., the high frequency portion of PSD 1208) is no longer a pure plateau. It has a noise signature of a high-frequency horizontal plateau followed by a higher-frequency slope, different from the white noise behavior which is flat over all frequencies as the noise of a given contour position along the edge is independent of all other noises in other contour positions.

The unique noise signature of the 2D feature indicates presence of correlation in the segmentation noise (which connects the segmentation errors in one contour position to the errors in other contour positions, such as the neighboring contour positions). Such noise signature is attributed to the fact that the feature has a 2D pattern rather than 1D pattern. In such cases, the above models, in particular the white noise model, are no longer applicable for fitting the PSD and estimating roughness for the 2D feature. There is a need to analyze the specific sources of such noises so as to determine how to accurately model the noises.

Referring now to FIG. 3, there is illustrated a generalized flowchart of denoising the PSD in accordance with certain embodiments of the presently disclosed subject matter.

The PSD data characterizing edge roughness of the feature can be obtained (302) (e.g., by the denoising module 112). The PSD data can be generated based on a set of images of the feature, as described above with reference to FIG. 2. In particular, in some cases, the feature of interest has a two-dimensional (2D) pattern (also referred to as a 2D feature), as exemplified in FIG. 12 as a non-limiting example. As compared to 1D features, a 2D feature tends to have a specific noise signature/behavior characterized by a plateau followed by a slope in the high-frequency range of the PSD data.

The high-frequency slope in the PSD indicates presence of correlation of the segmentation noise, which may arise due to two possible sources: 1) image noise auto-correlation, and/or 2) in cases where one pixel in a given image (of the set of images) impacts identification of two or more contour points of an actual contour of the feature in the given image. The two sources and how they may cause auto-correlation of the segmentation noise are specified in further detail below.

In some cases, the image noises in different pixels may be correlated with each other. Such correlated noise may arise due to several factors, such as, e.g., the beam interaction with the semiconductor specimen, the image acquisition and processing, etc., leading to different noise behaviors from random white noise. By way of example, in SEM and similar electron microscopy techniques, the primary electron beam penetrates the sample surface and interacts with the material to produce various signals, including secondary electrons (SE), and backscattered electrons (BSE), among others. The interaction volume refers to the three-dimensional region within the material where these interactions occur. These electrons, that are used to generate the SEM image, originate from within the interaction volume. Since this volume can extend in depth below the surface and across the material, the electrons that are eventually detected and contribute to the image signal, can originate from points within the sample that are physically apart from the target point of primary electron beam impact. This can lead to a situation where the noise (i.e., variations in the detected signal) at one pixel is correlated with the noise in neighboring pixels, because they are all influenced by the same underlying volume of material interactions.

However, the present disclosure has identified that the correlated noise is less prominent in SEM images that are generated based on a relatively higher number of frames. One possible reason could be that the image noise auto-correlation as described above may exist between neighboring pixels inside one frame, but there is much less correlation between these same pixels from different frames. When generating a SEM image, the gray level values of the pixels from multiple frames are combined and averaged. Thus, the auto-correlation of the resulting SEM image is naturally reduced as the number of frames increases.

As SEM images are typically acquired based on a relatively higher number of frames (e.g., higher than 16 frames) to ensure the image quality, image noise auto-correlation is assumed to be significantly reduced in these images. Based on such an assumption, the present disclosure considers the first noise source (i.e., image noise auto-correlation) to be irrelevant for the present noise analysis.

The second noise source refers to the scenario where one pixel in a given image of the set of images impacts identification of two or more contour points of an actual contour of the feature in the given image.

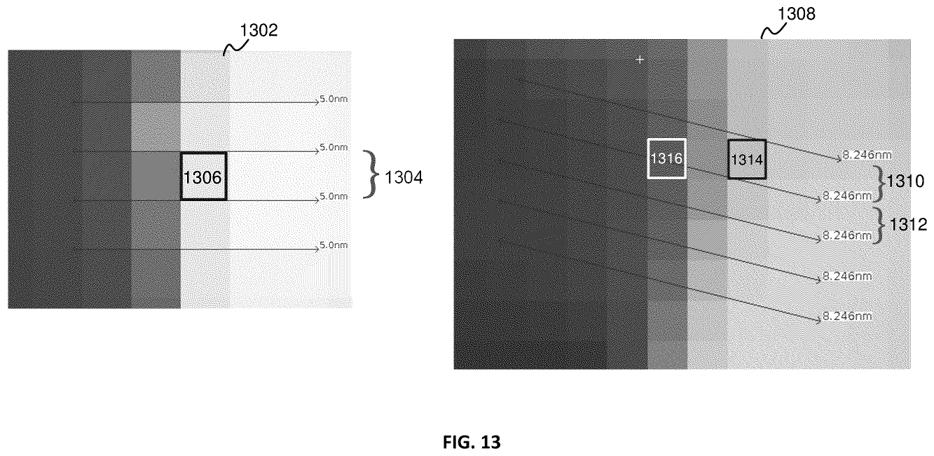

FIG. 13 is a schematic illustration of one pixel impacting contour extraction in two or more contour points in accordance with certain embodiments of the presently disclosed subject matter.

As described above, for purpose of estimating edge roughness, an actual contour of the feature is extracted from an image. The EPD between the actual contour (or a corrected contour thereof) and a reference contour is computed and used for generating the PSD data. Among various possible ways of contour extraction/segmentation, FIG. 4 illustrates an example of contour extraction, where the actual contour of a feature is extracted by identifying a plurality of contour points (also referred to as image points) in the given image corresponding to a plurality of reference points from a reference contour (derived from design data of the feature). The plurality of contour points constitutes the actual contour.

In cases of a 1D feature such as the vertical line 1202 exemplified in FIG. 12, the segmentation errors in defining the actual contour position for each point/location along the edge are independent from each other. In such cases, there is no correlation between segmentation noises of different contour positions along the edge. Image 1302 illustrates a magnified view of a part of the right edge of the vertical line 1202 at a pixel level. As shown, the pixels that affect the identification/determination of the contour/edge positions at each point along the edge are independent from each other.

As described above with reference to FIG. 5, contour points in the image can be determined by placing strips in a direction perpendicular to the edge represented by the reference contour. By way of example, for a horizontal strip 1304 across the edge which corresponds to the size of one pixel, the pixels that impact the determination of the actual contour pixel along the strip are completely independent from the neighboring strips (i.e., they are not overlapped in any way with the pixels in the other strips). For instance, a given pixel 1306 within the strip 1304 is not overlapped (or partially overlapped) with any pixels from the upper or lower neighboring strip. The segmentation error (if any) in determining the actual contour position in this strip is thus not related to the segmentation error in the other strips. Segmentation noises in such cases are not correlated, and are typically defined as white noises.

In comparison, for a 2D feature such as the ring structure 1204 exemplified in FIG. 12, image 1308 illustrates a magnified view of a part of the right edge (such as, e.g., the upper curved part) of the ring structure at the pixel level. Multiple strips can be similarly placed across the curved edge, in a direction perpendicular to the edge, as illustrated by the arrowed lines. Note that the strips are inclined so as to be perpendicular to the upper curved edge.

As shown, it is no longer true that pixels impacting the determination of the actual contour pixel in one strip are independent from the neighboring strips. In fact, some of the pixels are partially overlapped with more than one strip, due to the inclination. By way of example, pixel 1314 in strip 1310 may be partially overlapped with the upper neighboring strip (not numbered in the figure) and the lower neighboring strip 1312. Such a pixel spanning multiple strips would unavoidably affect the determination of the actual contour position in the three strips. By way of another example, pixel 1316 is partially overlapped with both strip 1310 and strip 1312, thus impacting the determination of the contour positions in these two strips.

The segmentation errors in determining the actual contour position in these strips are thus correlated with each other. Segmentation noises in such cases can no longer be defined as white noises, due to the presence of correlation.

In view of the above noise source analysis, certain embodiments of the present disclosure consider the fact of one pixel possibly impacting the identification of two or more contour points of an actual contour to be the cause for the correlation in the segmentation noises. Based on the nature of the assumed cause for the correlation, in some embodiments, a specific noise model can be created, based on an auto-correlation function of the segmentation noise.

Specifically, according to certain embodiments, the noise model can be defined as Fourier transform of a sum of a series of auto-correlation functions of the segmentation noise. In some cases, the series of auto-correlation functions include at least auto-correlation functions with a lag of zero, one, and two, respectively representing auto-correlation of the segmentation noise caused when a pixel spans at least one, two, and three strips.

By way of example, for a segmentation noise signal x(t), PSD of the segmentation noise can be represented by the Fourier Transform \hat{r}(f) of the auto-correlation function r(τ) of the segmentation noise x(t). The auto-correlation function r(τ) of x(t) can be represented as follows:

$$r ( τ ) = {\sum }_{t} E ( x ( t - τ ) x ( t ) )$$

where E refers to the expectation value, r(τ) refers to the correlation between the segmentation noise signal and itself with a lag (τ). In the above example, τ refers to the number of strips that a pixel possibly spans.

PSD of the segmentation noise signal can be represented as follows:

$$P S {D}_{n o i s e} ( f ) = \hat{r} ( f ) = {\sum }_{τ} r ( τ ) {e}^{- i 2 π f \times d \times τ} \times d$$

where d refers to the distance between two consecutive/neighboring strips, in nanometers (nm), and f is the frequency, in nm⁻¹.

With the above assumption, it can be presumed that at least r(0), r(1) and r(2) may not be zero, while r(τ>2)=0 or ≈0 (in cases with more complex 2D patterns).

By applying Fourier Transform, PSD of the segmentation noise can be represented as follows:

$$P S {D}_{n o i s e} ( f ) = {R}_{0} + {R}_{1} cos ( 2 π f d ) + {R}_{2} cos ( 2 \times 2 π fd )$$

$$where {R}_{0} = r ( 0 ) \times d , {R}_{τ} = 2 \times r ( τ ) \times d .$$

The above correlation-based noise model can be fitted (304) (e.g., by the denoising module 112), together with a roughness model, in the PSD data as obtained in block 302, to predict noise data representative of the segmentation noise. In some embodiments, the roughness model can be constructed based on a Lorentzian function, such as below:

$$P S {D}_{r o u g h n e s s} ( f ) = \frac{P S {D}_{0}}{1 + {( 2 π f ξ )}^{2 H + 1}}$$

where PSD₀ (also written as PSD(0)) refers to the value of the PSD in the low-frequency region, refers to correlation length, and H refers to the slope of the PSD in the mid-frequency range.

The roughness model and the noise model can be combined and fitted into the PSD data, as follows:

$$P S {D}_{model} ( f ) = \frac{P S {D}_{0}}{1 + {( 2 π f ξ )}^{2 H + 1}} + {R}_{0} + {R}_{1} cos ( 2 π f d ) + {R}_{2} cos ( 4 π fd )$$

By fitting the models in the PSD data, the noise parameters in the noise model (R₀, R₁ and R₂), as well as the roughness parameters (e.g., PSD₀, ξ, H, etc.) in the roughness model, can be properly approximated and predicted.

The predicted noise data (i.e., R₀+R₁ cos(2πfd)+R₂ cos(4πfd)) can be removed (306) (e.g., by the denoising module 112) from the PSD data, to obtain denoised PSD data. The denoised PSD data is usable for estimating denoised edge roughness of the feature.

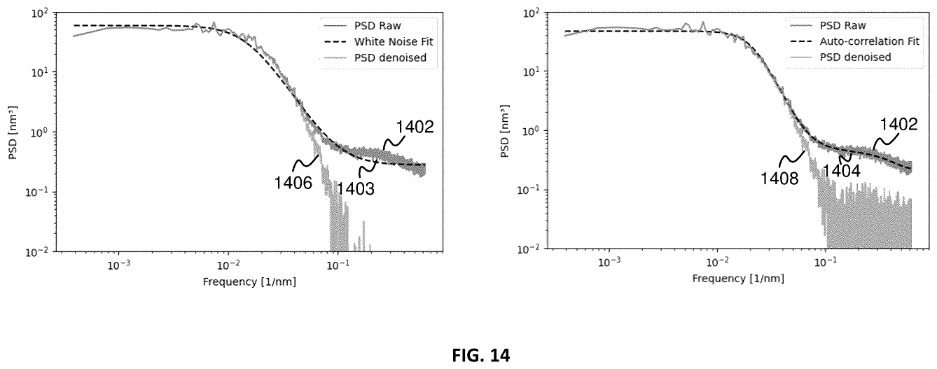

FIG. 14 shows a comparison between PSD data of a 2D feature fitted respectively with a white noise model and a correlation-based noise model in accordance with certain embodiments of the presently disclosed subject matter.

In the present example, PSD 1402 represents the PSD data generated for the left curved edge of the 2D ring feature 1204 illustrated in FIG. 12, based on the EPD between corrected contours (i.e., target contours) and the reference contour thereof. In the left illustration, a first PSD 1403 (illustrated by dashed line) fitted with a white noise model (together with a roughness model) is presented. Similarly, as described above with reference to the PSD 1208, PSD 1402 differentiates from the first PSD 1403 mainly in the high frequency region, where the first PSD 1403 remains flat, while the PSD 1402 presents a unique noise behavior of a high-frequency horizontal plateau, followed by a higher-frequency slope. The higher-frequency slope in the noise PSD indicates presence of correlation in the segmentation noise (which connects the segmentation errors in one contour position to the errors in other contour positions, such as the neighboring contour positions).

In comparison, in the right illustration, a second PSD 1404 (illustrated by dashed line) fitted with the proposed correlation-based noise model (together with a roughness model) is presented. As shown, PSD 1402 is well recovered with respect to the second PSD 1404 in almost all the frequency regions, in particular in the high frequency region, indicating that the proposed correlation-based noise model fits well in the segmentation noise PSD, and presents a good representation of the specific noise signature/behavior of the 2D pattern (characterized by a plateau, followed by a slope in the high-frequency range of the PSD data). In some cases, there may still be a small amount of fit error at the low frequency region, possibly due to optimization used in the fit and/or irregularities of the data.

After fitting the first PSD 1403 and second PSD 1404 respectively into PSD 1402, noise data can be estimated. By way of example, noise parameters in the correlation-based noise model (R₀, R₁ and R₂) can be approximated, as well as the roughness parameters (e.g., PSD₀, ξ, H, etc.) in the roughness model. As calculated, R₀=0.32, R₁=0.14, and R₂=0, indicating that in the present example, R₂ cos(2×2πfd)=0. As described above, r(τ) refers to the correlation between the segmentation noise signal and itself with a lag (τ), where τ refers to the number of strips that a pixel possibly spans. In the present example, r(2) has a value of zero, indicating there is no pixel spanning three strips that attributes to the correlation in the segmentation noises.

Upon removing the estimated noise data from PSD 1402, a denoised PSD can be generated. As exemplified, a denoised PSD 1406 (where the estimated white noise is removed from PSD 1402) is shown in the left illustration, while a denoised PSD 1408 (where the estimated correlation-based noise is removed from PSD 1402) is shown in the right illustration. In comparison, the denoised PSD 1408 is closer to the expected PSD than PSD 1406, thus proving that the noise removal in PSD 1408 is more effective. Roughness parameters are also estimated. For example, as calculated, PSD₀=45.3, ξ=9.09, and H=1.53.

The level of denoised edge roughness can be estimated based on these parameters. Using the above proposed correlation-based noise model enables to effectively reduce segmentation noise from the PSD data to a given extent, and allows accurate estimation of edge roughness.

In some embodiments, it is possible to add supplementary terms to the noise model, such as, e.g., R₃ cos(3×2πfd), R₄ cos(4×2πfd), etc., in cases where the fit residual of the segmentation PSD is larger than a given threshold (the fit residual refers to the discrepancy between the fit and the expected PSD, i.e., the high-frequency region fit still shows a deviation larger than a given threshold).

In some embodiments, in lieu of the correlation-based noise model, other types of noise models may be used. By way of example, since the segmentation noise behavior (e.g., a plateau followed by a slope) is similar to the behavior of the roughness PSD (e.g., a low-frequency plateau followed by a mid-frequency slope), a noise model based on a Lorentzian function can be used instead of the correlation-based model. The PSD data can thus be fitted by a noise model based on a Lorentzian function, and a roughness model which is also based on a Lorentzian function.

It is to be noted that although the proposed noise models are designed so as to fit the specific noise behavior caused due to 2D patterns, the noise models nevertheless fit 1D features as well. By way of example, when processing a 1D feature image, such as the vertical line 1202 in FIG. 12, it is proven that the proposed noise model can properly fit the PSD of the 1D feature, thus enabling effective denoising of the PSD data of 1D features as well.

It is to be noted that examples illustrated in the present disclosure, such as, e.g., the exemplified images and 1D/2D features, the exemplary PSD curves, and related approximation and estimations, etc., are illustrated for exemplary purposes, and should not be regarded as limiting the present disclosure in any way. Other appropriate examples/implementations can be used in addition to, or in lieu of the above.

Among advantages of certain embodiments of the presently disclosed subject matter as described herein, is providing a roughness estimation system for a 2D feature with any arbitrary shape, where the 2D feature may possess certain transformations in the actual manufacturing process with respect to the original design intent, such as, e.g., translations, rotations, and scaling, due to process variations, thus causing artifacts in the generated PSD data characterizing the roughness of the feature.

The present disclosure proposes to generate accurate PSD data for the 2D feature without artifacts (or with reduced artifacts), by first calculating any transformation between an actual contour outlining the feature in the images, and a reference contour from the original design layout of the feature, and correcting the actual contour with respect to the calculated transformation. PSD is only generated after such correction, based on the corrected feature contour, so as to reduce the presence of artifacts caused by the transformation.

Among further advantages of certain embodiments of the presently disclosed subject matter as described herein, is that using a specific way of contour extraction enables to obtain multiple pairs of corresponding points that are evenly distributed in space along the actual contour and reference contour, which is advantageous for correcting affine transformation, and is a pre-requisite for computing PSD. It results in more accurate correction and reduction of artifacts in the generated PSD data.

Among further advantages of certain embodiments of the presently disclosed subject matter as described herein, is to propose a correlation-based noise model based on the specific segmentation noise behavior for 2D features. The correlation-based noise model can fit well in the segmentation noise PSD, enabling effective noise reduction from the PSD data and denoised roughness estimation.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “estimating”, “providing”, “correcting”, “generating”, “aligning”, “extracting”, “sampling”, “identifying”, “computing”, “placing”, “averaging”, “analyzing”, “enabling”, “fitting”, “predicting”, “removing”, “representing”, “impacting”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the examination system, the roughness estimation system, and respective parts thereof disclosed in the present application.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer, and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates, including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed, for example, by employing image-processing techniques. Note that, unless specifically stated otherwise, the term “metrology”, or derivatives thereof used in this specification, is not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device and does not impact yield.

The term “runtime” used in this specification refers to the on-line examination process in the fabrication plant (FAB) where production wafers are fabricated. A setup phase refers to a recipe setup stage prior to its deployment in the runtime/production phase. A runtime specimen examination process has many performance requirements to meet, such as accuracy, throughput (TpT), etc. Therefore, care needs to be taken as to which operations should be completed during setup, and which operations should be performed in runtime, in order to meet such strict requirements.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats, such as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program, or a computer program product, which comprises instructions readable and executable by a computer (or a processor thereof) for performing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of estimating edge roughness of a feature on a semiconductor specimen, the system comprising a processing circuitry configured to:
obtain a set of images capturing the feature, and design data of the feature;
provide, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and
generate power spectral density (PSD) data based on edge placement difference (EPD) between each target contour in the set of target contours and the reference contour, wherein the PSD data is usable for estimating edge roughness of the feature.

2. The computerized system according to claim 1, wherein the feature is in a shape of a line or a two-dimensional (2D) polygon.

3. The computerized system according to claim 1, wherein the set of images comprise a plurality of images acquired by an examination tool from a plurality of sites on the semiconductor specimen, each site containing an instance of the feature.

4. The computerized system according to claim 1, wherein the transformation is obtained based on a plurality of pairs of corresponding points from the actual contour and the reference contour.

5. The computerized system according to claim 1, wherein the processing circuitry is configured to provide the target contour for the given image by:
aligning the given image with the reference contour extracted from the design data;
sampling a plurality of reference points from the reference contour;
identifying a plurality of image points on the given image corresponding to the plurality of reference points, giving rise to a plurality of pairs of corresponding points, the plurality of image points constituting the actual contour;
computing the transformation between the actual contour and the reference contour based on the plurality of pairs of corresponding points; and
correcting the actual contour based on the transformation, to obtain the target contour corresponding to the given image.

6. The computerized system according to claim 5, wherein the plurality of image points are identified by placing a plurality of strips respectively at locations of the plurality of reference points, each strip extending in a direction perpendicular to the reference contour, and obtaining, from each strip, a respective image point based on gray level intensities along the strip.

7. The computerized system according to claim 1, wherein the transformation is an affine transformation representative of at least one of translation, rotation, and scaling of the actual contour with respect to the reference contour.

8. The computerized system according to claim 1, wherein the PSD data is obtained by averaging among a set of individual PSD data, each corresponding to EPD between a respective target contour and the reference contour.

9. The computerized system according to claim 1, wherein by using the target contour instead of the actual contour, the generated PSD data possesses reduced artifacts caused by the transformation, which, when being used for the estimating of edge roughness, enables deriving roughness parameters with higher accuracy.

10. The computerized system according to claim 1, wherein the PSD data comprises noise data representative of segmentation noise induced by contour extraction in the set of images.

11. The computerized system according to claim 10, wherein the processing circuitry is further configured to fit a noise model, together with a roughness model, to the PSD data to predict the noise data, and remove the predicted noise data from the PSD data, to obtain denoised PSD data.

12. The computerized system according to claim 11, wherein the feature is in a shape of a two-dimensional (2D) polygon, and the noise model represents a specific noise behavior of the 2D polygon characterized by a plateau, followed by a slope in a high-frequency range of the PSD data.

13. The computerized system according to claim 11, wherein the noise model is based on an auto-correlation function of the segmentation noise.

14. The computerized system according to claim 11, wherein the processing circuitry is further configured to estimate edge roughness of the feature by analyzing the denoised PSD data to derive one or more roughness parameters representing state of edge roughness of the feature.

15. A computerized method of estimating edge roughness of a feature on a semiconductor specimen, comprising:
obtaining a set of images capturing the feature, and design data of the feature;
providing, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and
generating power spectral density (PSD) data based on edge placement difference (EPD) between each target contour in the set of target contours and the reference contour, wherein the PSD data is usable for estimating edge roughness of the feature.

16. The computerized method according to claim 15, wherein the providing the target contour comprises:
aligning the given image with the reference contour extracted from the design data;
sampling a plurality of reference points from the reference contour;
identifying a plurality of image points on the given image corresponding to the plurality of reference points, giving rise to a plurality of pairs of corresponding points, the plurality of image points constituting the actual contour;
computing the transformation between the actual contour and the reference contour based on the plurality of pairs of corresponding points; and
correcting the actual contour based on the transformation, to obtain the target contour corresponding to the given image.

17. The computerized method according to claim 16, wherein the plurality of image points are identified by placing a plurality of strips respectively at locations of the plurality of reference points, each strip extending in a direction perpendicular to the reference contour, and obtaining, from each strip, a respective image point based on gray level intensities along the strip.

18. The computerized method according to claim 15, wherein the PSD data comprises noise data representative of segmentation noise induced by contour extraction in the set of images, and the method further comprises fitting a noise model, together with a roughness model, to the PSD data to predict the noise data, and removing the predicted noise data from the PSD data, to obtain denoised PSD data.

19. The computerized method according to claim 18, wherein the feature is in a shape of a 2D polygon, and the noise model represents a specific noise behavior of the 2D polygon characterized by a plateau, followed by a slope in a high-frequency range of the PSD data.

20. A non-transitory computer readable storage medium tangibly embodying a program of instructions that, when executed by a computer, cause the computer to perform a method of estimating edge roughness of a feature on a semiconductor specimen, the method comprising:
obtaining a set of images capturing the feature, and design data of the feature;
providing, for each given image in the set, a target contour of the feature in the given image, giving rise to a set of target contours corresponding to the set of images, wherein the target contour is obtained by correcting an actual contour of the feature extracted from the given image, with respect to a transformation between the actual contour and a reference contour of the feature obtained from the design data; and
generating power spectral density (PSD) data based on edge placement difference (EPD) between each target contour in the set of target contours and the reference contour, wherein the PSD data is usable for estimating edge roughness of the feature.
